(19) United States
(12) Patent Application Publication
(10) Pub. No.: US 2026/0195839 A1
(43) Pub. Date: Jul. 9, 2026

(54) SYSTEMS AND METHODS FOR REAL-TIME COORDINATION OF EMERGENCY EVACUATIONS USING RESOURCE MATCHING AND CAPACITY-AWARE ROUTING

(71) Applicant: Liesl Marie Schwoebel, Benson, NC (US)

(72) Inventor: Liesl Marie Schwoebel, Benson, NC (US)

(21) Appl. No.: 19/436,762

(22) Filed: Dec. 30, 2025

Related U.S. Application Data
(60) Provisional application No. 63/742,148, filed on Jan. 6, 2025.

(51) Int. Cl. G06Q 50/26; G01C 21/34; G01C 21/36; G06Q 10/02; G06Q 10/0639; H04W 4/029; H04W 4/90

(52) U.S. Cl. CPC G06Q 50/265; G01C 21/3415; G01C 21/3461; G01C 21/3617; G01C 21/3679; G06Q 10/02; G06Q 10/06393; H04W 4/029; H04W 4/90

(57) ABSTRACT

A computer-implemented system for coordinating emergency evacuations, the system comprising components is configured to perform real-time resource matching, capacity-aware routing, and automated intake workflows. A server system receives evacuation requests and evaluates preregistered profiles of evacuees, transport providers, and facilities. A routing engine selects suitable transport providers based on proximity, capacity, and handling requirements, while a capacity evaluator reserves space at appropriate intake facilities based on real-time availability. During transit, tracking devices provide location updates enabling dynamic route adjustments based on capacity changes or detected hazards. Upon arrival, facility staff identify evacuees using one or more identification mechanisms to retrieve preregistered information and complete intake processing.. Automated notifications inform owners, drivers, facilities, and coordinators throughout the workflow. The system supports diverse evacuee types including animals, humans, and equipment, providing unified evacuation management across multiple jurisdictions and emergency scenarios.

### CROSS-REFERENCE TO RELATED APPLICATION

This application claims the benefit of U.S. Provisional Patent Application No. 63/742,148, filed Jan. 6, 2025, entitled “System and Method for Equine Evacuation Management,” the entire contents of which are incorporated herein by reference in their entirety under 35 U.S.C. § 119(e).

### FIELD OF THE INVENTION

The present invention relates generally to emergency evacuation systems and logistics coordination. More specifically, the invention concerns computer-implemented systems and methods for performing real-time matching of transportation resources to evacuees, dynamic routing based on facility capacity, and automated intake workflows supported by digital profiles, tracking devices, and multi-role interfaces.

### BACKGROUND OF THE INVENTION

Emergency evacuations involving subjects or objects including, but not limited to, animals (such as horses, livestock, and pets) or mobility-limited humans often occur under conditions of extreme time pressure, hazardous environmental change, and limited transportation and sheltering resources. Current evacuation systems and methods rely heavily on manual, uncoordinated communication channels including phone trees, text message threads, social media posts, volunteer callouts, and community bulletin boards.

These informal methods introduce significant inefficiencies, delays, and safety risks that can result in loss of life, injury, and property damage, including, but not limited to:

### Lack of Real-Time Visibility

Existing systems provide no unified view of critical evacuation parameters. Owners and responders cannot see available transportation providers, facility capacity status, driver availability, current road conditions, evacuee-specific requirements, or intake congestion levels. This information fragmentation forces decision-makers to operate without complete situational awareness.

### Inefficient Resource Allocation

Transport providers typically respond to evacuation needs in an ad hoc manner, resulting in mismatched trailer capacity, duplication of effort, arrival at facilities that have reached full capacity, unnecessary travel distances, and stalled intake processing. The absence of centralized coordination means that resources are often deployed inefficiently, leaving some evacuees without assistance while other areas receive redundant support.

### Missing or Incorrect Evacuee Information

Facilities frequently receive evacuees with no accompanying medical history, feeding requirements, behavioral notes, or proper identification data. This information gap leads to improper stall or containment assignments, delayed veterinary care, safety risks for facility staff and evacuees, and difficulties in reuniting evacuees with their owners after the emergency has passed.

### Absence of Dynamic Rerouting Capability

Emergency conditions evolve rapidly as wildfires spread, floodwaters rise, or other hazards develop. Manual communication methods cannot effectively redirect drivers in real time, reassign facilities based on changing capacity, notify owners of route changes, track evacuee locations during transit, or adapt to emerging hazards. This static approach increases exposure to danger and reduces evacuation efficiency.

### Fragmented Intake Processes

Intake facilities lack a standardized mechanism for scanning evacuees upon arrival, retrieving preregistered profiles, logging intake events, updating stall or space availability, and communicating arrival confirmations to owners. The result is chaotic intake procedures that create bottlenecks, errors, and delays precisely when speed and accuracy are most critical.

No fully integrated evacuation coordination platform currently exists that unifies preregistration workflows, real-time transport matching, facility capacity evaluation, dynamic routing, tracking device integration, structured intake workflows, and multi-role dashboards within a single system architecture.

The present invention addresses these and other deficiencies by providing a comprehensive, computer-implemented platform that automates and optimizes the entire evacuation process from initial request through final intake confirmation.

### SUMMARY OF THE INVENTION

The present invention provides a unified, computer-implemented evacuation management system through an integrated architecture comprising multiple interconnected subsystems.

### System Architecture

The invention includes a centralized server system with specialized processing modules including a routing engine for computing optimal transportation paths, a capacity evaluator for assessing facility availability in real time, and a notification manager for coordinating communications among all participants.

The system further includes a message broker enabling real-time bidirectional event updates between system components, allowing the platform to respond dynamically to changing conditions throughout the evacuation process.

A database layer stores preregistered profiles of evacuees, transport providers, intake facilities, and coordinating agencies. This preregistration approach ensures that critical information is available immediately when emergencies occur, eliminating delays associated with gathering information during crisis conditions.

User devices provide role-specific interfaces for owners, drivers, facility staff, and coordinators, with each interface tailored to the operational needs and information requirements of that particular role.

Tracking devices assigned to evacuees enable routing verification and intake confirmation through technologies including GPS, RFID, NFC, UWB, or geofence-enabled tags. These devices provide continuous visibility into evacuee location and status throughout the evacuation process.

### Core Functionality

The system performs dynamic routing adjustments based on facility capacity changes, environmental hazards, or transport availability. Unlike static routing systems, the invention continuously evaluates conditions and automatically reroutes transports to optimize safety and efficiency.

Automated intake workflows streamline the arrival process by identifying evacuees, retrieving preregistered profiles, assigning appropriate containment locations, and notifying owners of successful intake.. This automation eliminates manual data entry errors and accelerates processing during high-volume intake periods.

### Operational Process

In operation, the system receives an evacuation request and automatically matches transportation resources based on proximity, availability, capacity, and evacuee-specific requirements. The system then selects an appropriate intake facility based on real-time capacity information, generates routing instructions, and monitors conditions during transit to dynamically update routing or facility assignments as needed. The system further facilitates intake processes upon arrival and updates all participants throughout the workflow.

### Broad Applicability

Unlike existing systems that address only narrow use cases, this invention provides end-to-end operational orchestration supporting any type of evacuee including animals, pets, livestock, equipment, or mobility-restricted persons. The architecture is designed to accommodate diverse evacuation scenarios while maintaining consistent operational efficiency.

The system can be deployed at regional, state, or national levels, and can coordinate evacuations ranging from small-scale barn evacuations to large-scale disaster response operations involving thousands of evacuees and multiple jurisdictions.

### BRIEF DESCRIPTION OF THE DRAWINGS

The accompanying drawings illustrate exemplary embodiments of the invention and, together with the detailed description, serve to explain the principles of the invention. In the drawings:

FIG. 1 is a system architecture diagram showing the primary components of the evacuation coordination platform, including the server system with routing engine, capacity evaluator, and notification manager; the database layer, which may be implemented using relational, non-relational, event-based, or other data storage technologies (such as SQL and NoSQL data stores); the message broker for event-driven communication; user devices for owners, drivers, facilities, and coordinators; and tracking devices, which may include GPS, RFID/NFC, geofence-enabled tags, or other devices capable of providing identification, location, or status information, along with communication pathways connecting these component;

FIG. 2 is a workflow diagram illustrating the preregistration process by which evacuees, transport providers, facilities, and coordinators establish profiles within the system prior to emergency events, showing data flow from user input through validation to storage in the database layer;

FIG. 3 is a workflow diagram depicting the transportation matching process, showing how the system receives an evacuation request, evaluates available transport providers based on suitability criteria, selects an optimal provider, generates routing instructions to the pickup location, and handles fallback scenarios when no suitable provider is immediately available;

FIG. 4 is a workflow diagram illustrating the facility matching and dynamic routing process, showing how the system evaluates facility capacity in real time, reserves space at an appropriate facility, generates routing instructions to that facility, monitors conditions during transit, and dynamically reroutes transports when capacity changes or hazards emerge;

FIG. 5 is a workflow diagram depicting the arrival and intake process at a facility, showing how facility staff scan evacuee identification tags, retrieve preregistered profiles, assign containment locations, log intake events, and trigger automated notifications to owners and coordinators; and

FIG. 6 is an end-to-end workflow diagram showing the complete evacuation process from initial preregistration through request initiation, transportation matching, facility routing, in-transit monitoring, intake processing, and post-intake status updates, illustrating how all system components interact to provide comprehensive evacuation coordination.

### DETAILED DESCRIPTION OF THE INVENTION

In the following detailed description, reference is made to the accompanying drawings that form a part hereof and show by way of illustration specific embodiments in which the invention may be practiced. These embodiments are described in sufficient detail to enable those skilled in the art to practice the invention. It should be understood, however, that the embodiments may be practiced in various ways beyond the specific details described herein, and the invention is not limited to these particular embodiments. Other embodiments may be utilized and structural, logical, and operational changes may be made without departing from the scope of the present invention.

### 1. System Architecture Overview

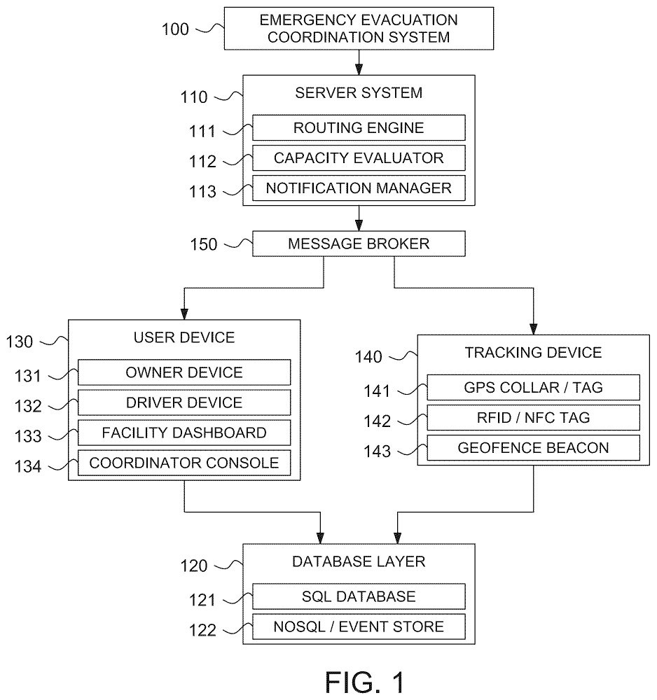

Referring to FIG. 1, an evacuation coordination system 100 comprises a distributed computing architecture designed to provide real-time coordination of emergency evacuations. The system includes multiple interconnected components that communicate via network connections to provide end-to-end evacuation management.

### 1.1 Server System

The server system 110 comprises one or more computing devices including processors, memory, and network interfaces. The server system may be implemented using physical servers, virtual machines, cloud computing instances, containerized microservices, or hybrid architectures combining on-premises and cloud-based resources.

The server system 110 includes several specialized processing modules that implement core evacuation coordination functionality:

### Routing Engine 111

The routing engine 111 computes transportation routes between pickup locations, intake facilities, and other relevant locations. The routing engine evaluates multiple factors including geographic distance, estimated travel time, road conditions, traffic patterns, known hazards, road closures, and environmental conditions such as wildfire boundaries, flood zones, or severe weather paths.

In various embodiments, the routing engine may implement Dijkstra's shortest-path algorithm, a heuristic pathfinding, multi-objective optimization considering both distance and risk factors, or machine-learning models trained on historical evacuation data to predict optimal routes. The routing engine interfaces with external mapping services, traffic data providers, and hazard monitoring systems to obtain current condition information.

The routing engine generates turn-by-turn navigation instructions that are transmitted to driver devices 132 and continuously monitors transport progress to detect deviations from planned routes or slower-than-expected progress that may indicate problems.

### Capacity Evaluator 112

The capacity evaluator 112 maintains real-time awareness of facility availability throughout the system. For each registered facility, the evaluator tracks total capacity, current occupancy, available space, and resource constraints such as medical capabilities, species accommodations, quarantine areas, or specialized equipment.

The capacity evaluator queries facility records stored in database layer 120 and evaluates incoming capacity update messages received via message broker 150. When an evacuation request is processed, the capacity evaluator identifies facilities with sufficient available capacity and appropriate resources to accommodate the evacuees.

The capacity evaluator reserves space at selected facilities by updating facility records and broadcasting reservation events to prevent double-booking. If facility capacity changes during an active evacuation (such as when a facility reaches maximum capacity or closes due to hazard proximity), the capacity evaluator triggers dynamic rerouting by the routing engine 111.

### Notification Manager 113

The notification manager 113 handles all communications with system participants. The notification manager generates and transmits messages to owner devices 131, driver devices 132, facility dashboards 133, and coordinator consoles 134 based on system events.

Notifications may be delivered through multiple channels including push notifications to mobile applications, SMS text messages, email, automated voice calls, or in-app messaging. The notification manager maintains delivery preferences for each user and implements retry logic to ensure critical notifications reach their intended recipients even during periods of network congestion or limited connectivity.

Examples of notifications include dispatch alerts sent to transport providers when they are selected for an assignment, routing instructions sent to drivers, facility arrival notifications sent to facility staff, owner updates confirming pickup and delivery, coordinator alerts regarding system-wide status, and rerouting instructions when conditions change.

### 1.2 Database Layer

The database layer 120 provides persistent storage for all system data using a hybrid architecture that combines structured and semi-structured data storage.

### SQL Database 121

The SQL database 121 stores structured relational data including evacuee profiles with fields for name, species, physical description, photograph, medical history, dietary requirements, behavioral notes, handling instructions, owner contact information, veterinarian contact information, and alternate emergency contacts.

Transport provider records include trailer capacity, equipment type (such as horse trailer, livestock trailer, pet transport van, or medical transport vehicle), certifications, insurance information, service areas, availability schedules, and performance history.

Facility records include name, address, geographic coordinates, total capacity, current occupancy, stall or containment configurations, species accommodations, medical capabilities, quarantine facilities, contact information, operating hours, and closure status.

Coordinator records include jurisdiction, authority level, contact information, and override permissions. Historical intake logs record all past evacuations for compliance, reporting, and analysis purposes.

The SQL database may be implemented using PostgreSQL, MySQL, Microsoft SQL Server, Oracle Database, or other relational database management systems. The database includes indexes on frequently queried fields such as evacuee identifiers, geographic coordinates, and facility capacity to ensure rapid query response during emergency operations.

### NoSQL/Event Store 122

The NoSQL or event store 122 stores high-throughput, semi-structured data including real-time transport location updates transmitted by tracking devices 140, capacity change events generated when facilities update their available space, routing status changes as transports progress along their assigned routes, geofence trigger events when evacuees or transports enter or exit defined geographic zones, intake confirmation events when evacuees arrive at facilities, and all other time-series operational events.

This event-driven architecture enables the system to maintain a complete audit trail of all actions and supports real-time stream processing for dynamic decision-making. The event store may be implemented using Apache Kafka, Apache Pulsar, Amazon Kinesis, Azure Event Hubs, MongoDB, Cassandra, DynamoDB, or other systems designed for high-throughput event ingestion and time-series data storage.

### 1.3 Message Broker

The message broker 150 implements a publish-subscribe messaging pattern that enables asynchronous, event-driven communication among all system components. Components publish messages to topics or channels, and other components subscribe to receive messages on topics of interest.

This architecture provides loose coupling between system components, allowing them to operate independently while maintaining coordination through message exchange. The message broker ensures message delivery during periods of network disruption by queuing messages until recipients are available to receive them or connectivity is restored through an alternative communication pathway.

Examples of message topics include transport location updates, facility capacity changes, routing instructions, intake confirmations, hazard alerts, and system status updates. The message broker may implement exactly-once delivery semantics to prevent duplicate processing of critical messages such as capacity reservations.

The message broker may be implemented using Apache Pulsar, Apache Kafka, RabbitMQ, MQTT brokers, NATS, Amazon SQS/SNS, Azure Service Bus, or proprietary messaging systems. In some embodiments, the message broker supports message replay functionality, allowing coordinators to review the sequence of events during an evacuation for analysis or troubleshooting.

### 1.4 User Devices

User devices 130 provide interfaces through which system participants interact with the evacuation coordination platform. Each device type presents a role-specific interface optimized for the tasks and information needs of that user role.

### Owner Device 131

The owner device 131 typically comprises a smartphone, tablet, or computer operated by an evacuee owner or responsible party. The owner device runs a client application (which may be a native mobile app, web application, or hybrid application) that communicates with server system 110 via network connections.

Through the owner device interface, users can preregister evacuees by entering profile information and uploading photographs, initiate evacuation requests by selecting evacuees and specifying pickup locations and urgency levels, monitor evacuation progress through map displays showing transport location and estimated arrival times, receive notifications regarding dispatch, pickup, en route status, and arrival, and confirm reunification with evacuees after the emergency has passed.

In some embodiments, the owner device interface includes features for uploading additional documents such as vaccination records or ownership papers, designating alternate contacts who may authorize decisions on behalf of the owner, and accessing facility contact information to arrange reunification.

### Driver Device 132

The driver device 132 typically comprises a smartphone or tablet operated by a transport provider. The driver device interface is optimized for navigation and status updates during active transport operations, including presentation of routing information via preexisting vehicle navigation systems or vehicle-mounted displays.

Through the driver device interface, transport providers can view available assignments, accept or decline transport requests, access turn-by-turn navigation to pickup locations and intake facilities, receive dynamic rerouting instructions when conditions change, confirm pickup by scanning evacuee identification tags or manually verifying evacuee identity, transmit location updates during transit, confirm delivery at intake facilities, and view assignment history and performance metrics.

The driver device interface may integrate with vehicle-mounted navigation systems, hands-free voice control, or dashboard-mounted displays to minimize distraction while driving. In some embodiments, the driver interface provides estimated fuel consumption, suggested refueling locations, and rest stop recommendations for long-distance evacuations.

### Facility Dashboard 133

The facility dashboard 133 provides facility staff with tools for managing incoming evacuees and facility capacity. The dashboard may be accessed through a web browser, dedicated application, or terminal interface and is typically displayed on desktop computers, tablets, or wall-mounted displays at intake facilities.

Through the facility dashboard, staff can view incoming transports with estimated arrival times and evacuee counts, access preregistered evacuee profiles including medical needs and handling instructions, scan evacuee identification tags upon arrival to automatically retrieve profiles and log intake, assign stalls, paddocks, pens, or other containment locations, update facility capacity as space fills or becomes available, mark specific areas as unavailable due to maintenance or hazards, record notes regarding evacuee condition or behavior, upload photographs documenting evacuee condition at intake, and communicate with owners and coordinators.

The facility dashboard presents a visual map of facility layout with color-coded indicators showing occupied and available spaces, allowing staff to quickly identify appropriate placement for incoming evacuees. In some embodiments, the dashboard includes inventory management tools for tracking feed, supplies, and equipment usage.

### Coordinator Console 134

The coordinator console 134 provides emergency managers and oversight personnel with system-wide visibility and control. The console typically comprises a desktop workstation or large-format display providing comprehensive situational awareness.

Through the coordinator console, authorized users can view all active evacuations on a regional map display, monitor transport locations and facility capacity in real time, identify bottlenecks or resource shortages, manually override automatic assignments when necessary, prioritize high-risk evacuees for expedited transport, activate multi-facility or multi-jurisdictional evacuation protocols, adjust hazard boundaries and closure zones, communicate with all participants simultaneously, generate reports for compliance and documentation, and configure system parameters and business rules.

The coordinator console may integrate with external emergency management systems, weather services, and interagency communication platforms. In some embodiments, coordinators can establish evacuation zones, automatically trigger evacuation requests for all registered evacuees within a zone, and track compliance with evacuation orders.

### 1.5 Tracking Devices

“Tracking devices 140 are assigned to evacuees to provide identification and location tracking throughout the evacuation process and may comprise wearable devices, attachable tags, embedded identifiers, or devices carried by evacuees or associated transport equipment. Multiple tracking technologies may be used depending on operational requirements, environmental conditions, and evacuee characteristics.

### GPS Collar or Tag 141

GPS tracking devices provide continuous geolocation data transmitted via cellular, satellite, or low-power wide-area networks. GPS devices may be attached to animals via collars, halters, leg bands, or adhesive tags, or may be carried by human evacuees or attached to equipment containers.

GPS tracking enables the system to verify that transports are following assigned routes, detect unexpected stops or route deviations that may indicate problems, confirm arrival at intake facilities, and locate evacuees if they become separated from transports. GPS devices may include accelerometers to detect movement patterns, tamper sensors to alert if devices are removed, and environmental sensors measuring temperature or humidity.

Battery life varies depending on transmission frequency, with some devices operating for days or weeks on a single charge. In some embodiments, GPS devices enter low-power mode during normal conditions and increase reporting frequency during active evacuations.

### RFID/NFC Tag 142

Radio-frequency identification (RFID) and near-field communication (NFC) tags provide short-range wireless identification without requiring line-of-sight scanning. These tags may be passive (powered by the reader's electromagnetic field) or active (battery-powered with longer read ranges).

RFID/NFC tags are particularly useful during intake processing, allowing facility staff to rapidly scan evacuees and automatically retrieve profiles without manual data entry. Tags may be embedded in ear tags, microchips, collar tags, wristbands, or adhesive patches. For animals with existing microchips, the system may be configured to read standard ISO microchip formats and associate chip identifiers with evacuee profiles.

The use of RFID/NFC technology accelerates intake processing and eliminates errors associated with visual identification or manual record lookup, particularly during high-volume intake operations when dozens or hundreds of evacuees may arrive simultaneously.

### Geofence Beacon 143

Geofence beacons detect entry into or exit from defined geographic zones. Beacons may use GPS coordinates, Bluetooth proximity detection, Wi-Fi positioning, or ultra-wideband (UWB) technology to determine location relative to zone boundaries.

Geofencing enables the system to trigger automated actions when evacuees or transports cross zone boundaries. For example, entry into a hazard zone may trigger alerts to coordinators, entry into a facility zone may initiate intake workflows, and exit from an expected route corridor may trigger rerouting or status checks.

In some embodiments, dynamic geofences are established around moving hazards such as wildfire perimeters or flood boundaries, and the system automatically adjusts these zones based on updated hazard forecasts or environmental sensor data.

### 1.6 Network Communication

System components communicate via multiple existing or future network technologies depending on availability and operational requirements. The system supports cellular networks (3G, 4G LTE, 5G), Wi-Fi networks, satellite communication, mesh networking protocols that enable devices to relay messages through other nearby devices, Bluetooth Low Energy (BLE) for short-range device communication, and hardwired Ethernet connections at facilities and coordination centers.

The system implements redundancy and failover mechanisms to maintain operation during network disruptions. Client applications cache data locally and synchronize with the server when connectivity is restored. Critical notifications may be delivered through multiple channels simultaneously to ensure receipt. In some embodiments, the system includes an offline mode that allows drivers and facility staff to continue operations without server connectivity, with data synchronization occurring once connection is reestablished.

All network communication may be encrypted using Transport Layer Security (TLS) or equivalent protocols to protect sensitive information including evacuee medical data, owner contact information, and facility locations.

### 2. Preregistration Workflow

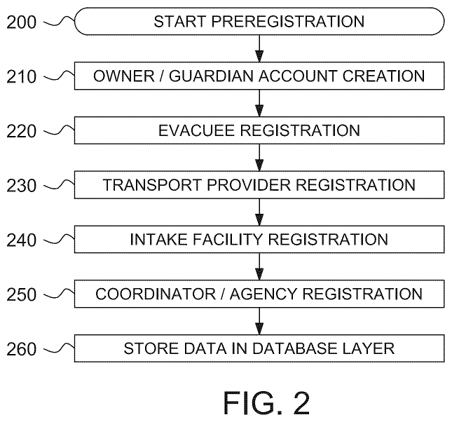

Referring to FIG. 2, a preregistration workflow 200 enables system participants to establish profiles before emergencies occur. Preregistration ensures that critical information is immediately available when evacuation requests are submitted, eliminating delays associated with gathering information during crisis conditions.

### 2.1 Evacuee Profile Registration

Evacuee owners (210) access the owner device 131 and navigate to a profile creation interface. The owner enters identifying information including evacuee name, species (if applicable), breed, age, sex, weight, height, coloring, and distinctive markings. The owner uploads one or more photographs showing the evacuee from multiple angles to aid in visual identification.

Medical information includes vaccination records, known health conditions, medications, allergies, dietary restrictions, special feeding instructions, and veterinarian contact information. Behavioral information includes temperament, handling notes, compatibility with other animals, and any special requirements such as isolation needs or handling precautions.

Emergency contact information includes owner name, phone numbers, email address, physical address, and alternate contacts authorized to make decisions regarding the evacuee. Some embodiments allow owners to upload supporting documents such as ownership papers, insurance information, or veterinary records.

Once the profile is submitted, server system 110 validates the information, assigns a unique identifier to the evacuee, and stores the profile in SQL database 121 (step 260). The system may generate an RFID/NFC tag encoded with the evacuee identifier for physical attachment to the evacuee. In embodiments where evacuees already have microchips, the owner enters the microchip number and the system associates it with the profile.

Owners may register multiple evacuees (220) and organize them into groups such as herds, flocks, or family units. This grouping information informs transport matching and facility assignment to keep related evacuees together when possible.

### 2.2 Transport Provider Registration (230)

Transport providers access a registration interface through a web portal or mobile application and create provider accounts including business name, contact information, service areas, and operating hours.

Providers specify equipment details including vehicle type, trailer configuration, capacity (number of evacuees that can be transported in a single trip), equipment features such as ramps, partitions, or climate control, and any specialized capabilities such as veterinary transport, livestock handling, or accessibility equipment for mobility-limited individuals.

Providers upload certification documents such as commercial driver's licenses, insurance certificates, USDA livestock transport permits, or other credentials required by regulatory authorities. Some embodiments include background check integration to verify provider credentials.

Providers indicate availability preferences including days and times they are available to respond to requests, maximum travel distance from their base location, and types of evacuees they are equipped to transport. Providers may update availability in real time to indicate when they are unavailable due to other commitments or when they become available to accept new assignments.

The server system 110 validates provider information, performs credential verification, and stores provider records in SQL database 121. Approved providers appear in the pool of available resources considered during transport matching.

### 2.3 Facility Registration (240)

Intake facility administrators register their facilities by providing facility name, address, geographic coordinates, contact information, and operating status. Administrators specify capacity information including total number of stalls, pens, paddocks, or other containment units, current occupancy, types of evacuees that can be accommodated (such as large animals, small animals, avian species, or human evacuees), and maximum capacity limits.

Facility capabilities include medical equipment, veterinary staff availability, quarantine areas, isolation facilities, climate-controlled spaces, outdoor areas, and specialized equipment such as wash racks, loading chutes, or examination rooms.

Administrators configure notification preferences indicating who should receive alerts about incoming evacuees, specify intake procedures and required documentation, and establish business rules such as whether the facility accepts evacuees from specific species, size ranges, or medical conditions.

The facility registration includes layout information that may be represented as a map or diagram showing the arrangement of containment areas. This information enables efficient stall assignment during intake processing.

Server system 110 validates facility information and stores facility records in SQL database 121. Facilities appear in the pool of available resources considered during facility matching and routing.

### 2.4 Coordinator Registration (250)

Emergency management agencies, animal control agencies, veterinary organizations, and other coordinating bodies register coordinator accounts with jurisdiction information, authority level, and oversight responsibilities. Coordinators receive access to the coordinator console 134 with permissions appropriate to their role.

Higher-tier coordinators may have authority to override automatic assignments, activate regional evacuations, modify system parameters, or access sensitive information across multiple jurisdictions. Lower-tier coordinators may have read-only access or limited to specific geographic areas or facility types.

The coordinator registration process includes identity verification and may integrate with existing emergency management credentialing systems to ensure only authorized personnel have access to system controls.

### 3. Transportation Matching Workflow

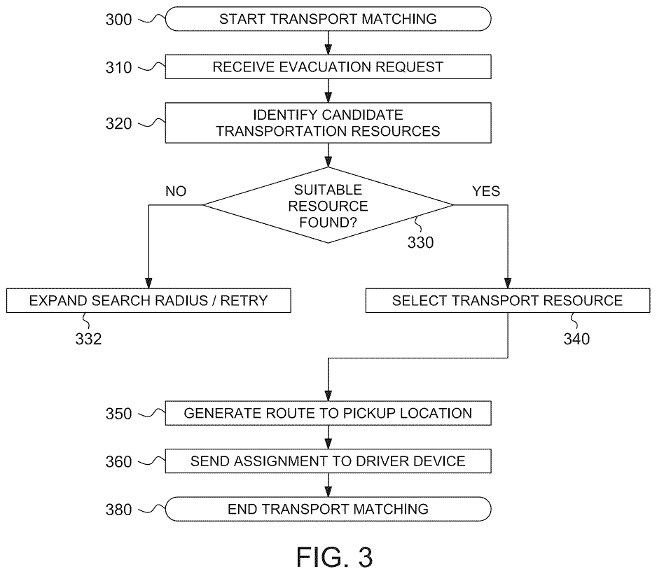

Referring to FIG. 3, a transportation matching workflow 300 executes when an evacuation request is received. This workflow identifies and assigns appropriate transport providers to pick up evacuees.

### 3.1 Request Initiation (310)

An owner accesses owner device 131 and initiates an evacuation request by selecting one or more registered evacuees, specifying a pickup location (which may be the evacuee's normal residence or a current location if the owner has already moved the evacuee), indicating urgency level (such as immediate, within hours, or precautionary), and optionally providing additional context such as reason for evacuation or special circumstances.

The evacuation request is transmitted to server system 110 and received by routing engine 111. The routing engine creates a request record stored in SQL database 121 and publishes a request event to message broker 150, making the request visible to other system components.

### 3.2 Provider Identification (320)

Routing engine 111 queries SQL database 121 to identify transport providers that meet basic eligibility criteria. The query filters providers based on service area (providers must be within a configurable maximum distance from the pickup location), current availability status (providers must have indicated they are available to accept assignments), and equipment compatibility (providers must have trailer configurations suitable for the evacuee type).

For example, if the request involves equines, the query identifies providers with horse trailers of sufficient capacity. If the request involves mobility-limited humans, the query identifies providers with wheelchair-accessible vehicles or medical transport equipment.

The query result returns a list of potentially suitable providers with their current locations, capacity, and availability windows.

### 3.3 Suitability Evaluation (330)

For each potentially suitable provider, routing engine 111 evaluates detailed suitability criteria including capacity match (the provider's trailer must have sufficient space for all evacuees in the request), distance to pickup location (shorter distances are preferred to minimize response time), provider ratings or performance history (if available), and specialized requirements (such as veterinary training, livestock handling experience, or medical certifications).

The routing engine assigns a score to each provider based on these factors using a weighted scoring algorithm. Weights may be configured by system administrators or learned from historical evacuation data using machine learning techniques.

In some embodiments, the routing engine considers current road conditions and estimated travel time rather than simple geographic distance. For example, a provider that is geographically closer but must travel on congested roads may be scored lower than a provider that is slightly farther but has an unobstructed route to the pickup location.

### 3.4 Provider Selection and Notification (340)

The routing engine selects the highest-scoring provider and generates a transport assignment record stored in SQL database 121. The assignment includes pickup location, evacuee information, estimated pickup window, and preliminary routing instructions.

Notification manager 113 transmits a dispatch notification to the selected provider's driver device 132. The notification includes assignment details and requires the driver to accept or decline the assignment within a specified time window (such as five or ten minutes).

If the driver accepts the assignment, routing engine 111 generates detailed turn-by-turn routing instructions from the driver's current location to the pickup location and transmits these instructions to driver device 132 (steps 350 and 360). The notification manager also sends a confirmation notification to owner device 131 informing the owner that a transport provider has been assigned with estimated arrival time.

### 3.5 Fallback Handling (332)

If the selected provider declines the assignment or does not respond within the specified time window, the routing engine automatically selects the next highest-scoring provider and repeats the notification process.

If no suitable provider is available within the initial search radius, the routing engine expands the search area incrementally and repeats the provider identification and evaluation process. The system may also query providers in adjacent regions or jurisdictions if configured to support cross-jurisdictional coordination.

If the expanded search still yields no suitable provider, the system escalates the request to coordinator console 134, alerting emergency managers that manual intervention is needed. Coordinators may contact providers directly, adjust system parameters to relax suitability criteria, or arrange alternative transportation through external resources.

In some embodiments, the system maintains a waitlist of unmatched requests and continuously re-evaluates the waitlist as provider availability changes, automatically assigning providers to waiting requests as they become available.

In some embodiments, coordinators may manually add or activate transport providers through the coordinator console, including standby or pre-positioned transport resources that were not previously registered or marked as available in the system. This capability enables rapid inclusion of ad hoc or emergency transport resources during large-scale or rapidly evolving evacuation events.”

### 4. Facility Matching and Dynamic Routing

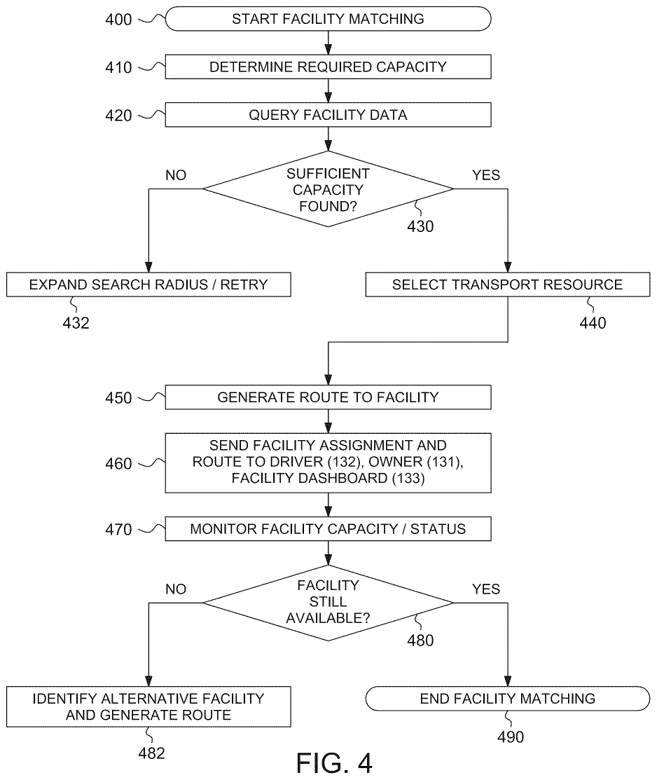

Referring to FIG. 4, a facility matching and routing workflow 400 executes after a transport provider has been assigned and is en route to the pickup location. This workflow determines the appropriate intake facility and generates routing instructions from the pickup location to that facility.

### 4.1 Capacity Evaluation (410)

When the driver confirms pickup (typically by scanning the evacuee's RFID/NFC tag 142 or manually confirming pickup via driver device 132), capacity evaluator 112 initiates facility selection. The capacity evaluator queries SQL database 121 to identify facilities that have available capacity and are suitable for the evacuee type.

The query filters facilities based on species accommodation (the facility must accept the evacuee's species), medical capabilities (if the evacuee has medical needs, the facility must have appropriate veterinary resources), behavioral considerations (if the evacuee requires isolation or special handling, the facility must have suitable accommodations), current capacity (the facility must have at least one available containment unit), and operational status (the facility must be open and accepting evacuees).

The query returns a list of suitable facilities with their current capacity, location, and suitability attributes.

### 4.2 Facility Scoring and Selection (420)

For each suitable facility, capacity evaluator 112 evaluates selection criteria including available capacity (facilities with more available space are preferred to maintain buffer capacity for subsequent arrivals), distance from pickup location (shorter distances reduce transport time and fuel costs), hazard proximity (facilities located closer to hazard zones are scored lower), current intake congestion (facilities that have recently received many evacuees may be experiencing processing delays), and facility capabilities (facilities with superior medical capabilities or amenities may be preferred for evacuees with special needs).

The capacity evaluator assigns a score to each facility using a weighted algorithm and selects the highest-scoring facility. The evaluator creates a capacity reservation record in SQL database 121, reducing the facility's available capacity by the number of evacuees being transported and marking the reserved space as temporarily unavailable to prevent double-booking.

In some embodiments, authorized facility personnel may manually override or adjust a capacity reservation through the facility dashboard when unregistered or previously unidentified evacuees arrive at the facility. Such an override updates the facility's real-time capacity information and may trigger dynamic rerouting of in-transit transports to alternative facilities based on updated capacity conditions.

### 4.3 Route Generation (450)

Routing engine 111 generates turn-by-turn routing instructions from the pickup location (or the transport's current location if already en route) to the selected facility. The routing engine considers real-time road conditions, traffic patterns, known hazards such as wildfire boundaries or flood zones, road closures or restrictions, and fuel availability along the route for long-distance transports.

The routing instructions are transmitted to driver device 132 and displayed as a navigable map with turn-by-turn directions, estimated travel time, and estimated arrival time at the facility.

Notification manager 113 sends a notification to facility dashboard 133 informing facility staff of the incoming transport, including estimated arrival time, number of evacuees, species, and any special handling or medical requirements. This advance notice allows facility staff to prepare appropriate containment areas and gather necessary resources.

The notification manager also sends an update to owner device 131 informing the owner of the selected facility and estimated arrival time.

### 4.4 In-transit Monitoring (470)

During transit, tracking devices 140 transmit location updates to server system 110 via message broker 150. The routing engine monitors transport progress by comparing actual location against the planned route and expected progress based on travel time estimates.

If the transport deviates significantly from the planned route, travels slower than expected, or stops for an extended period, the routing engine publishes an alert event to message broker 150. Notification manager 113 may send status check messages to driver device 132 or escalate alerts to coordinator console 134 if the driver does not respond.

In some embodiments, tracking devices 140 include panic buttons or emergency alert functions that drivers can activate if they encounter problems, triggering immediate coordinator notification and emergency response protocols.

### 4.5 Dynamic Rerouting (480)

If conditions change during transit, the system may execute dynamic rerouting to adjust the transport's destination or route. Several conditions may trigger rerouting including facility capacity changes (if the originally selected facility reaches maximum capacity or closes unexpectedly, capacity evaluator 112 selects an alternative facility), hazard developments (if environmental monitoring systems detect that the planned route passes through or near newly developed hazards, routing engine 111 computes an alternative route avoiding the hazard area), road closures (if traffic or emergency management systems report road closures affecting the planned route), or coordinator overrides (if emergency managers determine that transports should be redirected for operational reasons).

When rerouting is triggered, capacity evaluator 112 cancels the original capacity reservation, identifies and scores alternative facilities, and reserves capacity at a new facility. Routing engine 111 computes a new route and transmits updated routing instructions to driver device 132.

Notification manager 113 sends rerouting notifications to all affected parties including the driver (with new destination and routing instructions), the owner (with updated facility information and estimated arrival time), the original facility (canceling the incoming transport notification), the new facility (with incoming transport details), and coordinators (with rerouting justification and status).

The driver device 132 displays the updated route and automatically adjusts navigation instructions. In some embodiments, the driver device provides voice notifications alerting the driver to the rerouting and confirming that new navigation is available.

This dynamic rerouting capability distinguishes the present invention from static routing systems and provides critical adaptability during rapidly evolving emergency situations.

### 5. Arrival and Intake Workflow

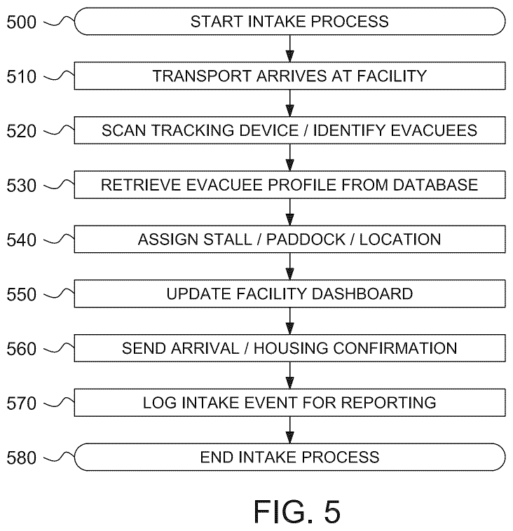

Referring to FIG. 5, an arrival and intake workflow 500 executes when a transport arrives at the assigned intake facility. This workflow automates intake processing, reducing manual data entry and accelerating evacuee placement.

### 5.1 Arrival Detection (510)

When the transport enters a geofence zone surrounding the facility, tracking devices 140 detect the zone entry and transmit arrival notifications to server system 110 via message broker 150. Alternatively, the driver may manually indicate arrival by interacting with driver device 132.

Server system 110 publishes an arrival event to message broker 150, which triggers notifications to facility dashboard 133 alerting staff that the transport has arrived and intake processing should begin.

### 5.2 Evacuee Scanning (520)

Facility staff use scanning devices (which may be handheld RFID/NFC readers, smartphones with NFC capability, or tablets running the facility dashboard application) to scan evacuee identification tags 142 as evacuees are unloaded from the transport.

The scanning device reads the unique identifier from the tag and transmits a scan event to server system 110. For evacuees with GPS tracking devices 141, facility staff may alternatively enter the GPS device identifier or the system may automatically associate the evacuee based on GPS location showing arrival at the facility.

For evacuees without electronic identification, facility staff may manually search for evacuee records by entering identifying information such as name, species, or physical description.

### 5.3 Profile Retrieval (530)

Upon receiving a scan event, server system 110 queries SQL database 121 using the evacuee identifier to retrieve the complete evacuee profile including identification information, photographs, medical history, dietary requirements, handling instructions, owner contact information, and any special notes or alerts.

The evacuee profile is transmitted to facility dashboard 133 and displayed for facility staff review. Staff can view photographs to confirm identity, review medical and behavioral information to inform placement decisions, and access handling instructions to ensure safe processing.

### 5.4 Stall Assignment (540)

Based on the evacuee profile information, facility staff (or in some embodiments, an automated assignment algorithm) select an appropriate containment location such as a stall, paddock, pen, kennel, or room. The selection considers evacuee size (the containment area must be appropriately sized), species compatibility (if multiple species are present, incompatible species should be separated), medical requirements (evacuees requiring medical monitoring may be placed in designated medical areas), behavioral considerations (aggressive or anxious evacuees may require isolation from others), and owner preferences (if owners specified particular requirements, these may be accommodated when possible).

The facility dashboard 133 displays a visual map of facility layout with color-coded indicators showing occupied and available spaces. Staff select an available location from the map, and the system updates the containment assignment record in SQL database 121, marking the location as occupied and associating it with the evacuee identifier.

In some embodiments, the system generates placement recommendations based on suitability scoring, suggesting optimal locations that balance the factors noted above.

### 5.5 Intake Logging (550)

Facility staff record intake confirmation through facility dashboard 133. The intake record includes arrival timestamp, assigned containment location, evacuee condition notes (such as observations about the evacuee's physical condition, behavior, or demeanor upon arrival), photographs documenting condition at intake, and staff member name or identifier.

Server system 110 stores the intake record in SQL database 121 and publishes an intake confirmation event to message broker 150. This event updates the evacuee status from “in transit” to “sheltered” and triggers a cascade of subsequent actions.

### 5.6 Capacity Update

The capacity evaluator 112 receives the intake confirmation event and updates the facility's available capacity, reducing it by one unit. If the intake fills the last available space or brings the facility to a configured capacity threshold (such as 90% full), the capacity evaluator may automatically update the facility's operational status to closed or at-capacity, preventing the facility from being selected for new transports until capacity becomes available.

The updated capacity information is stored in SQL database 121 and broadcast to coordinator console 134 to maintain system-wide situational awareness.

### 5.7 Stakeholder Notifications (560)

Notification manager 113 receives the intake confirmation event and transmits notifications to multiple parties including the evacuee owner at owner device 131 (confirming successful intake, providing facility contact information, and indicating the assigned containment location), the transport driver at driver device 132 (confirming delivery completion and releasing the driver from the assignment), and coordinators at coordinator console 134 (updating system-wide evacuation status).

The owner notification may include instructions for reunification such as facility visiting hours, identification requirements for retrieving evacuees, and estimated timeframes for reunification based on emergency conditions.

In some embodiments, the system generates automated periodic updates to owners while their evacuees are sheltered, such as daily status notifications confirming the evacuee remains safe and providing any relevant updates about condition or facility status.

### 6. End-to-end Evacuation Workflow

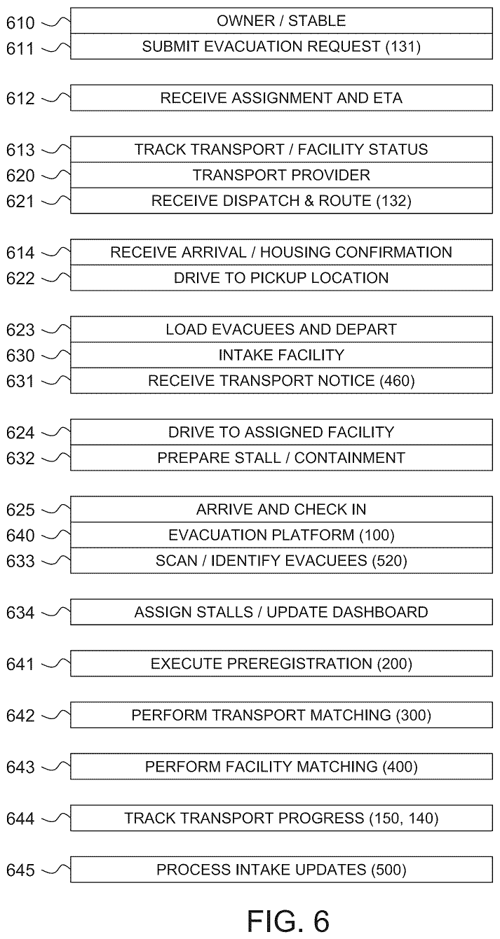

Referring to FIG. 6, an end-to-end evacuation workflow 600 illustrates the complete process from preregistration through post-intake status updates, showing how all system components interact to provide comprehensive evacuation coordination. The workflow includes steps 610-645 as reflected in FIG. 6 and as further described below:

### 6.1 Preregistration Phase

Prior to any emergency, owners register evacuees, transport providers register their capabilities and availability, facilities register capacity and resources, and coordinators establish monitoring permissions. This preregistration creates a ready pool of resources that can be activated immediately when emergencies arise.

### 6.2 Request Initiation

When an emergency occurs (such as a wildfire, flood, hurricane, or other hazard requiring evacuation), owners submit evacuation requests through owner devices 131. Alternatively, coordinators may trigger mass evacuation protocols that automatically generate requests for all registered evacuees within defined geographic zones.

### 6.3 Transportation Matching

Server system 110 executes the transportation matching workflow 300, identifying suitable transport providers, scoring candidates, selecting optimal providers, and transmitting dispatch notifications. This matching process occurs within seconds or minutes, providing rapid response during time-critical situations.

### 6.4 Pickup Execution

Transport providers navigate to pickup locations using routing instructions displayed on driver devices 132. Upon arrival, drivers confirm evacuee identity by scanning identification tags 142 or by manually verifying evacuee identity through the driver device. This confirmation triggers the facility matching phase.

### 6.5 Facility Routing

Server system 110 executes the facility matching and routing workflow 400, evaluating facility capacity, selecting appropriate intake facilities, generating routes, and transmitting navigation instructions to drivers. Facilities receive advance notice of incoming transports, allowing them to prepare for arrival.

### 6.6 In-transit Monitoring

During transit, tracking devices 140 continuously transmit location updates. Server system 110 monitors progress and detects anomalies such as route deviations or unexpected delays. If hazards develop or facility capacity changes, dynamic rerouting adjusts transport destinations in real time.

### 6.7 Intake Processing

Upon arrival at facilities, the intake workflow 500 executes. Staff identify evacuees using automated or manual identification methods, retrieve preregistered profiles, assign containment locations, and confirm intake. The system updates capacity, logs intake events, and notifies all stakeholders of successful placement.

### 6.8 Post-intake Status

After intake, evacuees transition to sheltered status. Facility staff monitor evacuee condition, provide care according to profile specifications, and record any significant events or condition changes. Owners receive periodic updates and can access current status through owner devices 131.

When emergency conditions subside, reunification workflows guide owners through the process of retrieving their evacuees, including verification of identity, acknowledgment of care provided, and transfer of custody documentation.

### 6.9 System Reset

After reunification, evacuee records return to preregistered status, available for future evacuations if needed. Transport providers return to available status and may accept new assignments. Facilities update capacity as evacuees depart, making space available for subsequent operations.

All events and records are preserved in SQL database 121 and event store 122 for compliance reporting, performance analysis, and continuous improvement of system operations.

### 7. Alternative Embodiments and Variations

The invention may be practiced in various configurations beyond the specific embodiments described above, and the scope of the invention is not limited to these particular implementations.

### 7.1 Alternative Tracking Technologies

While GPS, RFID, and NFC tracking devices have been described, other tracking technologies may be employed including Bluetooth Low Energy (BLE) beacons providing proximity detection and indoor location tracking, ultra-wideband (UWB) tags offering precise location tracking in complex environments, satellite-based IoT trackers using networks such as Iridium or Globalstar for remote area coverage, QR code identifiers that can be scanned using smartphone cameras, existing microchip implants in animals associated with evacuee profiles, mesh network trackers that communicate through neighboring devices in areas with limited infrastructure, temporary adhesive patches with embedded NFC chips, and wearable sensors capable of monitoring physiological parameters such as heart rate or body temperature to detect evacuee stress or medical issues.

Each tracking technology provides the core functionality of unique identification and status verification while offering different tradeoffs regarding cost, range, battery life, and environmental suitability.

### 7.2 Alternative Routing Approaches

The routing engine may implement various routing algorithms and optimization approaches including dynamic estimated time of arrival (ETA) recalculation based on current progress and traffic conditions, hazard-aware pathfinding incorporating wildfire perimeters, flood boundaries, tornado tracks, hurricane wind fields, or other environmental hazards, machine learning models trained on historical evacuation data to predict route closure likelihood or transit delays, multimodal routing combining different transportation types such as truck transport followed by ferry crossing or airlift, and convoy routing for grouped evacuations where multiple transports travel together for safety or efficiency.

Some embodiments implement predictive routing that anticipates future hazard positions based on forecast models and selects routes that minimize exposure to areas that may become hazardous during transit.

### 7.3 Alternative Evacuee Types

While examples have focused on animals and mobility-limited humans, the system architecture supports diverse evacuee types including large animals (horses, cattle, llamas, camels), small animals (dogs, cats, rabbits), exotic animals (reptiles, birds, amphibians), livestock (poultry, pigs, sheep, goats), zoo animals with specialized care requirements, aquatic animals in portable tank systems, non-ambulatory medical patients requiring specialized transport equipment, high-value equipment such as generators, medical devices, or research instruments, and critical documents or digital assets stored in secure containers.

The system adapts to each evacuee type by adjusting suitability criteria, capacity calculations, facility matching rules, and handling protocols. For equipment evacuations, “medical needs” may represent technical specifications, and “handling requirements” may represent security or environmental controls.

### 7.4 Alternative Facility Types

Intake facilities may include traditional animal facilities (barns, stables, kennels, veterinary clinics), temporary facilities (sports arenas, fairgrounds, school gymnasiums converted to shelters), specialized facilities (quarantine centers, wildlife rehabilitation facilities, medical triage centers), mobile facilities (tents, trailers, modular structures deployed in response to specific emergencies), tiered facilities organized by service level (basic shelter, medical monitoring, intensive care), and distributed facilities (private properties, ranches, or homes registered to accept small numbers of evacuees).

The system supports facilities of varying scales from small private locations accepting one or two evacuees to large regional centers capable of sheltering thousands.

### 7.5 Offline and Low-Connectivity Variants

In regions with limited network coverage, the system may operate in degraded modes including local data caching where mobile devices store evacuee profiles, facility information, and routing data for offline access, store-and-forward messaging where devices queue messages and transmit them when connectivity is restored, mesh networking protocols allowing devices to relay messages through nearby devices, local coordinator hubs with offline routing capability that synchronize with the central server when connectivity allows, and satellite communication backup providing low-bandwidth connectivity in areas without cellular coverage.

These offline capabilities ensure the system can continue functioning during emergencies that disrupt communication infrastructure.

### 7.6 Enhanced Automation

Some embodiments incorporate additional automation including autonomous or semi-autonomous transport vehicles that navigate to pickup locations without human drivers, unmanned aerial vehicles (UAVs or drones) conducting aerial route reconnaissance to identify road closures or hazards, automated intake systems using computer vision to identify evacuees and robotic systems to sort and place them, and predictive algorithms that anticipate evacuation demand based on weather forecasts or hazard models and preposition resources before requests are submitted.

### 7.7 Integration With External Systems

The system may integrate with external platforms including weather services providing real-time hazard information, traffic management systems providing road condition data, emergency management systems sharing situational awareness across agencies, veterinary practice management systems for seamless medical record transfer, insurance company systems for claims processing and coverage verification, and government databases for regulatory compliance reporting.

These integrations enhance the system's awareness and enable coordinated response across organizational boundaries.

### 7.8 Coordinator Override Capabilities

While the system operates primarily through automated workflows, coordinators retain authority to manually override automatic decisions including transport provider selection (assigning specific drivers to specific requests), facility assignment (directing transports to particular facilities for strategic reasons), route selection (specifying routes that avoid particular areas or pass through checkpoints), prioritization (marking certain evacuees as high-priority for expedited processing), and capacity management (manually adjusting facility capacity or operational status).

All override actions are logged in event store 122 for audit purposes and to inform future system improvements.

### 8. Advantages and Benefits

The present invention provides numerous technical and operational advantages over existing evacuation coordination methods.

### 8.1 Real-Time Resource Coordination

Unlike manual coordination methods relying on phone calls and text messages, the invention provides instant visibility into available transportation providers, facility capacity, and evacuee status. This real-time awareness enables optimal resource allocation and eliminates delays associated with iterative communication.

### 8.2 Capacity-Aware Routing

The invention continuously monitors facility capacity and dynamically adjusts routing decisions as conditions change. This prevents transports from arriving at facilities that have reached capacity, a common problem in manual coordination that wastes time and resources and may endanger evacuees by prolonging their exposure to hazardous conditions.

### 8.3 Automated Intake Processing

By automatically identifying evacuee information using one or more identification mechanisms, including identification tags, wearable devices, chain-of-custody events, or other automated identification techniques, and retrieving preregistered profiles, the invention eliminates manual data entry during intake processing. This automation accelerates processing during high-volume intake periods when dozens or hundreds of evacuees may arrive within short time windows, and reduces errors associated with manual record-keeping under stressful conditions.

### 8.4 End-to-End Workflow Integration

Existing systems typically address only isolated aspects of evacuation coordination such as resource tracking or facility management. The present invention provides comprehensive integration spanning preregistration, request management, transportation matching, routing, in-transit monitoring, intake processing, and status reporting within a unified platform. This integration eliminates information gaps and coordination failures that occur when different phases of evacuation are managed by separate, non-integrated systems.

### 8.5 Multi-Stakeholder Communication

The invention automatically distributes notifications to all relevant parties based on system events, eliminating the need for manual communication and reducing the risk that critical information fails to reach intended recipients. Owners, drivers, facility staff, and coordinators all maintain consistent situational awareness throughout the evacuation process.

### 8.6 Adaptability to Changing Conditions

The dynamic rerouting capability enables the system to respond to rapidly evolving emergency conditions by adjusting transportation routes and destinations in real time. This adaptability is critical during wildfires, floods, and other hazards that develop or spread unpredictably, and distinguishes the invention from static evacuation plans that cannot accommodate unexpected changes.

### 8.7 Scalability

The architecture supports evacuations ranging from individual requests involving single evacuees to mass evacuations involving thousands of evacuees across multiple jurisdictions. The use of message broker 150 and distributed database architectures enables the system to scale horizontally by adding computing resources as demand increases.

### 8.8 Data Preservation for Compliance and Analysis

By logging all events in event store 122, the invention maintains a complete audit trail of evacuation operations. This historical data supports compliance reporting to regulatory authorities, performance analysis to identify operational improvements, and research into evacuation logistics and animal welfare.

It should be understood, of course, that the foregoing relates to exemplary embodiments of the invention and that modifications may be made without departing from the spirit and scope of the invention as set forth in the following claims.

What is claimed is:

1. A computer-implemented system for coordinating emergency evacuations, comprising:
a server system comprising one or more processors and memory storing instructions that, when executed, cause the server system to:
receive an evacuation request associated with one or more evacuees;
access preregistered profile information associated with the one or more evacuees, a plurality of transport providers, and a plurality of intake facilities;
select a transport provider from the plurality of transport providers based on suitability criteria comprising at least one of: proximity to a pickup location, availability status, transport capacity, transport configuration, or evacuee-specific requirements;
determine an intake facility from the plurality of intake facilities based on real-time facility capacity information and suitability for housing the one or more evacuees; generate routing instructions directing the selected transport provider from the pickup location to the determined intake facility;
receive location information from a tracking device associated with at least one of the one or more evacuees or the selected transport provider;
dynamically adjust the routing instructions based on at least one of: a change in facility capacity, a detected hazard condition, or the location information; and
transmit notifications to at least one user device associated with at least one of: an evacuee owner, the selected transport provider, the determined intake facility, or an emergency coordinator.

2. The system of claim 1, wherein the transport configuration comprises at least one of: trailer type, trailer capacity, partitioning configuration, loading equipment, climate control capability, or specialized handling equipment.

3. The system of claim 1, wherein the evacuee-specific requirements comprise at least one of: species type, size, weight, medical needs, dietary requirements, behavioral characteristics, or compatibility with other evacuees.

4. The system of claim 1, wherein dynamically adjusting the routing instructions comprises:
detecting that the determined intake facility has reached a capacity threshold;
identifying an alternative intake facility from the plurality of intake facilities based on updated real-time facility capacity information;
generating updated routing instructions directing the selected transport provider to the alternative intake facility; and
transmitting the updated routing instructions to a user device associated with the selected transport provider.

5. The system of claim 1, wherein the detected hazard condition comprises at least one of: a wildfire boundary, a flood zone, a road closure, a severe weather area, or a contamination zone, and wherein dynamically adjusting the routing instructions comprises generating an alternative route that avoids the detected hazard condition.

6. The system of claim 1, wherein the tracking device comprises at least one identification or tracking mechanism, including at least one of: a GPS tracking device, an RFID tag, an NFC tag, a Bluetooth Low Energy beacon, an ultra-wideband tag, or a geofence-enabled device.

7. The system of claim 1, wherein the instructions further cause the server system to:
receive identification information associated with at least one of the one or more evacuees from an identification source at the determined intake facility;
retrieve profile information corresponding to the identification information from a database;
record an intake event associating the at least one evacuee with a containment location at the determined intake facility; and
update the real-time facility capacity information based on the intake event.

8. The system of claim 1, wherein the one or more evacuees comprise at least one of: an animal, a mobility-limited human, equipment, or an object requiring relocation during an emergency event.

9. A computer-implemented method for coordinating emergency evacuations, the method comprising:
receiving, by a server system, an evacuation request associated with one or more evacuees;
retrieving, from a database, preregistered profile information for the one or more evacuees, a plurality of transport providers, and a plurality of intake facilities;
selecting a transport provider from the plurality of transport providers based on at least one of: proximity to a pickup location, availability status, or transport capacity;
identifying an intake facility from the plurality of intake facilities based on real-time capacity information indicating available space at the intake facility;
generating routing instructions for the selected transport provider from the pickup location to the identified intake facility;
receiving telemetry information from a tracking device associated with at least one of the one or more evacuees or the selected transport provider;
modifying the routing instructions based on at least one of: a change in the real-time capacity information or a hazard condition detected along a route defined by the routing instructions;
receiving identification information associated with at least one of the one or more evacuees from an identification source at the identified intake facility;
retrieving evacuee profile information based on the identification information;
recording an intake event indicating arrival of at least one evacuee at the identified intake facility; and
transmitting notifications to user devices associated with at least one of: an evacuee owner, the selected transport provider, the identified intake facility, or an emergency coordinator.

10. The method of claim 9, wherein selecting the transport provider comprises:
calculating a suitability score for each of a plurality of candidate transport providers based on a plurality of weighted criteria comprising at least one or more weighted suitability criteria, including; distance to the pickup location, trailer capacity, equipment features, provider availability, or provider performance history; and
selecting the transport provider having the highest suitability score from among the plurality of candidate transport providers.

11. The method of claim 9, wherein identifying the intake facility comprises:
evaluating a plurality of candidate intake facilities based on one or more facility suitability criteria, including at least one of: available capacity, distance from the pickup location, species accommodation capabilities, medical resources, or proximity to hazard zones;
assigning a facility score to each of the plurality of candidate intake facilities; and
identifying the intake facility having a highest facility score from among the plurality of candidate intake facilities.

12. The method of claim 9, further comprising:
creating a capacity reservation at the identified intake facility, the capacity reservation reducing an available capacity count for the identified intake facility; and
broadcasting a capacity update event to a message broker, the capacity update event indicating the reduced available capacity count.

13. The method of claim 9, wherein the evacuee profile information comprises at least one of: identifying characteristics, photographic images, medical history, dietary requirements, handling instructions, behavioral notes, owner contact information, or emergency contacts.

14. A non-transitory computer-readable medium storing instructions that, when executed by one or more processors of a server system, cause the server system to perform operations comprising:
receiving an evacuation request associated with one or more evacuees;
accessing preregistered information from a database, the preregistered information comprising evacuee profiles, transport provider profiles, and facility profiles;
selecting a transport provider based on evaluating one or more suitability criteria, including at least one of: geographic proximity, availability, capacity, or specialized capabilities;
determining an intake facility based on evaluating real-time facility capacity data;
generating routing instructions from a pickup location to the intake facility;
receiving real-time updates from tracking devices associated with at least one of: the one or more evacuees or the transport provider;
adjusting the routing instructions responsive to detecting at least one of: a facility capacity change or an environmental hazard; and
transmitting status notifications to user devices associated with stakeholders in an evacuation process.

15. The non-transitory computer-readable medium of claim 14, wherein the operations further comprise:
monitoring location information from a GPS tracking device during transit from the pickup location to the intake facility;
detecting a route deviation based on comparing the location information to an expected route defined by the routing instructions; and
transmitting an alert to at least one of: a user device associated with the transport provider or a coordinator console.

16. The non-transitory computer-readable medium of claim 14, wherein determining the intake facility comprises:
filtering the facility profiles to identify facilities having available capacity and compatibility with evacuee characteristics;
scoring the identified facilities based on one or more weighted facility suitability criteria, including at least one of: available space, distance, hazard proximity, or facility capabilities; and
selecting a highest-scoring facility as the intake facility.

17. The non-transitory computer-readable medium of claim 14, wherein adjusting the routing instructions comprises:
receiving a facility capacity update indicating that the intake facility has reached maximum capacity;
identifying an alternative facility having available capacity;
generating updated routing instructions directing the transport provider to the alternative facility;
canceling a capacity reservation at the intake facility; and
creating a new capacity reservation at the alternative facility.

18. The non-transitory computer-readable medium of claim 14, wherein the operations further comprise:
receiving identification data associated with an evacuee from an identification source;
querying the database using the identification data to retrieve an evacuee profile;
displaying the evacuee profile on a facility dashboard interface;
receiving, via the facility dashboard interface, a containment location assignment; and
updating facility capacity data based on the containment location assignment.

19. The non-transitory computer-readable medium of claim 14, wherein the preregistered information comprises at least one of:
evacuee profiles comprising species classification, size parameters, medical conditions, dietary restrictions, or behavioral characteristics;
transport provider profiles comprising vehicle type, trailer configuration, capacity metrics, certifications, or service areas; or
facility profiles comprising total capacity, current occupancy, species accommodations, medical capabilities, or operational status.

20. The non-transitory computer-readable medium of claim 14, wherein the operations further comprise implementing a message broker configured to:
receive event messages from system components comprising at least one of:
location updates, capacity changes, intake confirmations, or hazard alerts; and
distribute the event messages to subscribed components based on publish-subscribe messaging patterns, thereby enabling real-time coordination among distributed system components.
